(19) United States
(12) Patent Application Publication
(10) Pub. No.: US 2014/0279274 A1
(43) Pub. Date: Sep. 18, 2014

(54) METHODS AND SYSTEMS FOR FACILITATING WEB-BASED PURCHASES

(71) Applicant: Billeo, Inc., Santa Clara, CA (US)

(72) Inventors: Murali B. Subbarao, Saratoga, CA (US); Suzanne D. Usiskin, Palo Alto, CA (US)

(73) Assignee: BILLEO, INC., Santa Clara, CA (US)

(21) Appl. No.: 14/204,017

(22) Filed: Mar. 11, 2014

Related U.S. Application Data
(60) Provisional application No. 61/778,907, filed on Mar. 13, 2013.

(51) Int. Cl. G06Q 30/06

(52) U.S. Cl. CPC G06Q 30/0635
USPC 705/26.81

(57) ABSTRACT

A method implementable on a transaction server for facilitating a web-based purchase without a user visiting one or more merchant websites or without one or more merchants requiring to change anything on their websites is disclosed. The method includes receiving a request from a user via a marketplace server to make a purchase for at least one item at the one or more merchants. At least a portion of user data associated with the user is transmitted to the one or more merchants for a checkout processing of the request. One or more status messages pertaining to the checkout processing of the request are displayed to the user along with one or more review order messages for confirmation. Lastly, method includes applying the web-based purchase for the at least one item at the one or more merchants based on the confirmation to proceed with the purchase.

### CROSS-REFERENCE TO RELATED APPLICATION

This application claims benefit to U.S. Provisional Patent Application No. 61/778,907, filed on Mar. 13, 2013, which is incorporated by reference in its entirety.

### TECHNICAL FIELD

The presently disclosed embodiments are related to web-based purchases. More particularly, the presently disclosed embodiments are related to methods and systems for facilitating web-based purchases at one or more merchants without the user visiting a website corresponding to each of the one or more merchants or without one or more merchants requiring to change anything on their websites.

### BACKGROUND

Over the last several years, the Internet has seen expansive growth in the area of electronic commerce. Several companies operate on web-based platforms to provide options for the users to shop and buy products online, a mode of business, which is known as Business to Consumer (B2C) online shopping. This allows the users to shop over the Internet from the companies in the privacy of their home. While a consumer may not be able to physically see the products while shopping on the Internet, the consumer may be able to view pictures of the products, have textual description of the products, as well as read reviews of the products.

Examples of some of the online sellers, which are frequently used for shopping by different users globally, include Best Buy®, Target®, Home Depot®, J. Crew®, etc. Each of these online shopping service providers has its own website, where a user may log on to buy products/services. Some online retailing organizations are confined to operate in specific domains, and provide a limited number of products and/or services only. Further, most of the predominantly operative online sellers optimize their websites with Search Engine Optimization techniques so that a web search on web-based search engines such as Google®, and Yahoo® will showcase their websites higher on the search results web page. Thus, when a user inputs a specific search query to obtain the options to buy a specific product online, on any of said search engines, the results page list on said search engine renders appropriate options indicating the different online sellers, which have that specific searched product available. The user may then click on a specific option in the result list, based on his interest, to buy a product, or obtain a specific service from the online seller of choice.

During the process of buying the product online, a user may perform a web search on a web-search engine for a product and once the user finds a relevant product, the user is re-directed to a merchant website for logging into the merchant website, adding a selected item to a cart, inputting card and shipping details etc. Thus, this process consumes a lot of time, especially for those users who frequently shop online.

Further, in a “marketplace” that aggregates products from multiple merchants, when a user decides to make a purchase through the marketplace, the user is redirected to a merchant website, where the user has to traverse several pages and fill/select several forms to complete the purchase. Thus, merchant websites find it tedious and costly to integrate with partners and do not want to change their order fulfillment systems easily.

One of the key issues related to marketplace websites and merchant websites is that ‘distance’ between a buying moment (Here: an intent to make a purchase) and the actual checkout has a negative impact on conversion rates. That is, higher the number of web clicks required to complete the sales, lower is the probability of the click ending up in a sale.

Based on the above, there is need for methods and systems that provide an efficient and quicker technique for online shopping that saves users time and avoids the need for the user to visit the seller's website, and without having the merchant to change anything on their website or their order fulfillment process.

### SUMMARY

According to the embodiments illustrated herein, there is provided a method implementable on a transaction server for facilitating a web-based purchase at one or more merchants. The transaction server is interconnected with one or more users and the one or more merchants through a network. The method includes receiving a request from a user to make a purchase for at least one item of goods or services at the one or more merchants without the user visiting a website corresponding to each of the one or more merchants. The method further includes transmitting automatically at least a portion of user data associated with the user to the one or more merchants for a checkout processing of the request. The checkout processing includes adding the at least one item of goods or services to one or more shopping carts at the one or more merchants; and filling/selecting at least one of one or more fields at the one or more merchants with at least the portion of the user data. The method further includes presenting to the user one or more status messages pertaining to the checkout processing of the request while performing the checkout processing of the request at the one or more merchants. Further, one or more review order messages corresponding to the at least one item of goods or services and at least one of one or more filled/selected fields received from the one or more merchants for confirmation. Lastly, the method includes applying the web-based purchase for the at least one item of goods or services at the one or more merchants based on the confirmation. One or more purchase confirmation messages are then received from the one or more merchants based on the applying. Thereafter, the one or more purchase confirmation messages are presented to the user.

According to the embodiments illustrated herein, there is provided a web transaction system for facilitating a web-based purchase at one or more merchants. The web transaction system includes a purchase request module, a checkout traversal module, a presentation module, a reviewing module, and a transaction module. The purchase request module is configured for receiving a request from a user to make a transaction module for at least one item of goods or services at the one or more merchants without the user visiting a website corresponding to each of the one or more merchants. The checkout traversal module is configured for traversing through one or more pages of merchant website for completing a purchase. Further, checkout traversal module is configured for checkout processing of the request. The checkout traversal module transmits automatically at least a portion of user data associated with the user to the one or more merchants of the request. The checkout traversal module then adds the at least one item of goods or services to one or more shopping carts at the one or more merchants, and fills/selects at least one of one or more fields at the one or more merchants with at least the portion of the user data. The presentation module is configured for presenting to the user one or more status messages pertaining to the checkout processing of the request by the checkout traversal module while the checkout traversal module performs the checkout processing of the request at the one or more merchants. Further, the presentation module transcodes data read from checkout pages and translates the pages for presentation to users. The reviewing module is configured for generating one or more review order messages corresponding to the at least one item of goods or services, and at least one of one or more filled/selected fields received from the one or more merchants for a confirmation from the user. The one or more review order messages are then presented to the user by the presentation module. Lastly, the transaction module is configured for applying the web-based purchase for the at least one item of goods or services at the one or more merchants based on the confirmation, and generating one or more purchase confirmation messages that are presented to the user by the presentation module.

According to the embodiments illustrated herein, there is provided a computer program product for use with a computer. The computer program product including a computer-usable data carrier storing a computer-readable program code embodied therein. The computer-readable program code configured for facilitating a web-based purchase at one or more merchants on a transaction server. The computer-readable program code includes program instruction means for receiving a request from a user to make a purchase for at least one item of goods or services at the one or more merchants without the user visiting a website corresponding to each of the one or more merchants. The computer-readable program code includes program instruction means for transmitting automatically at least a portion of user data associated with the user to the one or more merchants for a checkout processing of the request. The checkout processing includes adding the at least one item of goods or services to one or more shopping carts at the one or more merchants. The checkout processing further includes filling/selecting at least one of one or more fields at the one or more merchants with at least the portion of the user data. The computer-readable program code includes program instruction means for presenting to the user one or more status messages pertaining to the checkout processing of the request while performing the checkout processing of the request at the one or more merchants. The computer-readable program code includes program instruction means for presenting to the user one or more review order messages corresponding to the at least one item of goods or services and at least one of one or more filled/selected fields received from the one or more merchants for confirmation. The computer-readable program code includes program instruction means for applying the web-based purchase for the at least one item of goods or services at the one or more merchants based on the confirmation. Lastly, the computer-readable program code includes program instruction means for presenting to the user one or more purchase confirmation messages received by the one or more merchants after applying the web-based purchase.

### BRIEF DESCRIPTION OF DRAWINGS

The accompanying drawings illustrate various embodiments of systems, methods, and embodiments of various other aspects of the invention. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a web transaction system environment for facilitating web-based purchases in accordance with various embodiments;

FIG. 2 is a block diagram illustrating a web transaction system for facilitating web-based purchases in accordance with various embodiments;

FIG. 3 to 8 are screenshots illustrating various actions performed for facilitating web-based purchases in accordance with at least one embodiment;

FIG. 9 is a flow diagram illustrating a method implementable on a transaction server for facilitating web-based purchases in accordance with at least one embodiment; and

FIG. 10 is a screenshot illustrating an action performed for facilitating web-based purchases in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes, as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

In this description, the terms ‘comprises,’ ‘comprising,’ ‘includes,’ ‘including,’ or any other variation thereof, are intended to cover a non-exclusive inclusion, such that a process, article, system or apparatus that comprises a list of elements does not include only those elements, but may include other elements not expressly listed or inherent to such a process, article or apparatus.

The term ‘another’, as may be used in this document, is defined as at least a second or more.

The term “purchase and “web-based purchase” are interchangeably used.

### DEFINITIONS

The following terms shall have, for the purposes of this application, the respective meaning set forth below.

A “network” refers to a medium that connects various computing devices, and application servers. Examples of a network include, but are not limited to, LAN, WLAN, MAN, WAN, and the Internet. Communication over the network may be performed in accordance with various communication protocols such as Transmission Control Protocol and Internet Protocol (TCP/IP), User Datagram Protocol (UDP), IEEE 802.11n communication protocols, or the like.

A “computing device” refers to a device with a processor/microcontroller and/or any other electronic component, or a device or a system that performs one or more operations according to one or more programming instructions. Examples of a computing device include, but are not limited to, a desktop computer, a laptop, a personal digital assistant (PDA), a tablet computer (e.g., iPad®, Samsung Galaxy Tab®), a smartphone, or the like.

A “marketplace” refers to an entity that aggregates products from various merchants, attract shoppers with ‘extra’ value, drives traffic or sales to merchant, may or may not sell own products, and makes revenue through ads, clicks, or commissions. Examples of a marketplace Amazon®, E-Bay®, Facebook®, Nextag®, PriceGrabber®, Hukkster®, etc.

FIG. 1 is a block diagram illustrating a web transaction system environment 100 for facilitating web-based purchases in accordance with various embodiments. The system environment 100 includes a first computing device 102, a network 104, a merchant server 106, a second computing device 108, a transaction server 110, and marketplace server 112 respectively. The first computing device 102, the merchant server 106, the second computing device 108, the transaction server 110, and the marketplace server 112 are interconnected to each other over the network 104.

In the present description, only one type of the first computing device 102 and the second computing device 108 (hereinafter refereed as the computing device) are shown for simplicity. However, it will be apparent to a person having ordinary skill in the art that the disclosed embodiments can be implemented for a variety of computing devices including, but not limited to, a desktop computer, a laptop, a personal digital assistant (PDA), a tablet computer (e.g., iPad®, Samsung Galaxy Tab®), a mobile phone, a smartphone, or the like.

The computing device may include input device(s), such as keyboard, pointing device (e.g., mouse), pen, voice input device, touch input device, etc. The computing devices may also include output device(s), such as a display, speakers, printer, or the like. In an embodiment, the computing devices are configured to run an operating system software program and one or more software applications, which make up a system platform. In another embodiment, the computing devices include a software component that can be included as part of the operating system or can be included later as a software download.

The merchant server 106 host websites of one or more merchants and is interconnected to the computing device (which is operated by at least one user of one or more users) over the network 104. Examples of the merchant websites can be, Best Buy®, Target®, Home Depot®, J. Crew®, etc.

The transaction server 110 is an intermediary between the websites of the one or more merchants and the one or more users. In one embodiment, the transaction server 110 acts as a single source of data entry, and performs the purchase for the purchase of at least one item of goods or services, for the at least one user, at the one or more merchants, without the user visiting the websites of the one or more merchants.

The marketplace server 112 is a front-end website for users where a user initiates an activity of making a purchase for at least one item of goods or services. The marketplace server 112 interacts with the transaction server 110 that receives all the requests of the user from the marketplace server and performs the purchase of at least one item of goods or services at the one or more merchants on behalf of the user

Interaction among the system components of the system environment 100 is described later in conjunction with FIG. 2.

FIG. 2 is a block diagram illustrating a web transaction system 200 for facilitating web-based purchases in accordance with various embodiments. In an example embodiment, the web transaction system 200 corresponds to the transaction server 110.

The web transaction system 200 includes a processor 202 and a memory 204. The processor 202 is coupled with the memory 204. The processor 202 is configured to execute a set of instructions stored in the memory 204 to perform one or more operations. The processor 202 fetches the set of instructions from the memory 204 and executes the set of instructions. The processor 202 can be realized through a number of processing unit technologies known in the art. Examples of the processing unit include an X86 processor, a RISC processor, or any other suitable processor.

The memory 204 is configured to store the set of instructions or modules. Some of the commonly known memory implementations can be, but are not limited to, a random access memory (RAM), a read-only memory (ROM), a hard disk drive (HDD), and a secure digital (SD) card. The memory 204 includes a program module 206 and a program data 208. The program module 206 includes a set of instructions that are executable by the processor 202 to perform specific actions for facilitating the web-based purchases. It is understood by a person with ordinary skill in the art that the set of instructions in conjunction with the various hardware of the web transaction system 200 enable the web transaction system 200 to perform various operations. The program module 206 includes a purchase request module 210, a checkout traversal module 212, a presentation module 214, a reviewing module 216, a transaction module 218, a reporting module 220, and an authentication module (not shown in drawings).

The program data 208 includes a wallet 222. The wallet 222 is a storage medium that stores the data submitted from and/or required by the purchase request module 210, the checkout traversal module 212, the presentation module 214, the reviewing module 216, the transaction module 218, the reporting module 220, and the authentication module. In an embodiment, the wallet 222 can be implemented using technologies, including, but not limited to Oracle®, IBM DB2®, Microsoft SQL Server®, Microsoft Access®, PostgreSQL®, MySQL®, and SQLite®. In another embodiment, wallet 222 can be implemented in a Cloud.

In an embodiment, the wallet 222 is configured to store at least a portion of user data associated with each of one or more users. The at least portion of the user data of each of the one or more users include profiles of each of the one or more users, which represent all personal information of each of the one or more users including full name, or the like. The at least portion of the user data may further include the details particular to each merchant website of the one or more merchants where each of the one or more users has registered until date.

The at least portion of the user data of each of the one or more users further include each of the one or more users payment method details. The one or more users payment method details corresponds to multiple payment method details of the one or more users such as payment using debit card, credit card, net banking, or the like. The at least portion of the user data of each of the one or more users further include one or more shipping addresses. The one or more shipping addresses correspond to multiple shipping addresses of each of the one or more users. The at least portion of the user data of each of the one or more users further include one or more billing addresses associated with the one or more payment method details. The at least portion of the user data of each of the one or more users further include one or more shipping methods. The one or more shipping methods corresponds to multiple shipping options preferences for each of the one or more users such as shipping by private courier, shipping by government post, or the like. The at least portion of the user data of each of the one or more users further include each of the one or more users login details corresponding to the one or more merchants. Each of the one or more user's login details correspond to a user name and password for each of the websites of the one or more merchants. For example, each of the one or more users may provide login details for each of the one or more merchants such as Amazon®, Best Buy®, or E-Bay®. The at least portion of the user data of each of the one or more users may include one or more default preferences for the one or more payment method details, the one or more shipping options, and one or more personal details. One of the one or more default preferences corresponds to a default preference for a specific merchant of the one or more merchants. In one example, the each user of the one or more users may have a default preference for the Amazon® merchant that comprises the payment method as debit card payment, the shipping option as shipping by private courier, and the personal detail may include office address. In another example, the each user of the one or more users may have a default preference for the Best Buy® merchant that comprises the payment method as credit card payment, the shipping option as shipping by government post, and the personal detail may include home address.

In an embodiment, the present invention is initiated when a “buying moment” for at least one item of goods or services is created. Here, the buying moment can be defined as intent for making a purchase of at least one item of goods or services without visiting the website of the merchant.

In an embodiment, the purchase process of at least one item of goods or services (hereinafter referred to as the at least one item) is initiated when at least one user (hereinafter referred as a user) of the one or more users accesses any web-search engine via the internet using the web browser installed on the computing device. Here, one or more search results can be displayed to a user related to a search criterion (e.g. product name) and each search result has an associated URL that can be used to trigger the purchasing process. In another embodiment of the present invention, the purchase process of at least one item of goods or services (hereinafter referred to as the at least one item) is initiated when a user may click on a hyperlink or button related to at least one item on any of the social networking websites such as a post in Facebook®, tweet in Twitter®, pin in Pinterest®, photo in Instagram®, product on a Catalog, etc. In yet another embodiment of the present invention, the purchase process of at least one item of goods or services (hereinafter referred to as the at least one item) is initiated when a user clicks on advertisements posted on various internet websites, when a user scans QR codes associated with advertisements on a piece of paper, when a user scans QR codes associated with advertisements on various billboards, or the like without moving out from the scope of disclosed embodiments.

In an embodiment, the user inputs a search query on the search engine at the computing device to find the one or more merchants selling the at least one item. The user then selects the at least one item to be purchased from at least one merchant (hereinafter referred as a merchant) of the one or more merchants displayed in the search results on the computing device. It will be apparent and understood by a person with ordinary skill in the art that the user may simultaneously select the at least one item from a plurality of merchants without moving out from the scope of disclosed embodiments. It will also be apparent and understood by a person with ordinary skill in the art that the user may simultaneously select a plurality of items from one merchant or the plurality of merchants without moving out from the scope of disclosed embodiments. It will also be apparent and understood by a person with ordinary skill in the art that the user may simultaneously select two or more different items from two or more different merchants without moving out from the scope of disclosed embodiments.

In one example, the user may select the at least one item from the merchant of the one or more merchants displayed in the search results on the computing device by clicking on the merchant name. In such as case, the user will then be redirected to the website of the merchant that displays one or more items for sale, a list comprising the name of those one or more items. The website of the merchant will also include the price, description, and any other relevant information presented in Hypertext Markup Language (HTML) in the regarding the one or more items. The user may then select the at least one iter from the one or more of the items to add to one of his/her universal on line shopping lists (carts).

In another example, the user may select the at least one item from the merchant of the one or more merchants displayed in the search results on the computing device by clicking on a button integrated along with the at least one item displayed in the search results at the computing device. Here, once, the user activates the button, a request is forwarded to the transaction server 110.

The user after selecting the at least one item at the merchant, raises a request to make a purchase for purchasing the at least one item. In an embodiment, the purchase request module 210 is configured for receiving the request from the user to make the purchase for the at least one item from the merchant. In an embodiment, the request received by the purchase request module 210 include details corresponding to the at least one item to be selected, the name of the merchant from where the at least one item is to be selected, the URL of the merchant, one or more web pages of merchant website where at least one item may be added to a shopping cart, one or more images of at least one item, color of the at least one item, title of of at least one item, original price of at least one item, sale price of at least one item, coupon code for a discount of at least one item, color preference of the at least one item, size preferences of the at least one item, and quantity of the at least one item. In another embodiment, the request received by the purchase request module 210 may also include details corresponding to login credentials of the user for activating the transaction server 110. In yet another embodiment, URL of the product web page at the merchant website passed to the transaction server 110 may include one or more coupon codes associated with the product URL. These coupon codes can be automatically applied without the user having to type it in. In yet another alternative embodiment, once the user selects the at least one item for making a purchase, the user is required to authenticate with the transaction server 110 using the authentication module (not shown in the drawings).

In an embodiment, once the user is authenticated, the wallet 222 appears on the user interface at the computing device. The methods of authentication may include but not limited to (a) native authentication managed by the transaction server 110, (b) third party authentication through OAuth mechanism, (c) authentication of the user and a mobile phone via a Mobile Network Operator (MNO), and the like. The wallet 222 may display at least the portion of user details associated with the user such as credit/debit card details; user's preferable shipping address, or the like on the user interface at the computing device. It is to be noted that the user details are accessible to the user upon successful entry of credentials for accessing the transaction server 110. In another embodiment where there is no authentication required, the user is required to enter the payment method details, shipping method details, and the like in order to complete the purchase.

In an embodiment, the wallet 222 is either maintained by the transaction server 110 or is a third party wallet that passes the stored credentials to the transaction server 110 via API calls.

In an embodiment, once the user is authenticated, the purchase request module 210 is also configured for receiving the request from the user to make the purchase for the at least one item from the merchant. Thereafter, once the purchase request module 210 confirms the receipt and validity of the request from the authentication module, the checkout traversal module 212 then initiates a check-out processing of the request. Firstly, the checkout traversal module 212 analyzes the details of the request and then determines the at least one merchant where the web-based purchase for the at least one item is to be performed.

The checkout traversal module 212 after determining the location (URL) of the at least one merchant (i.e. web page within the merchant website that lists the selected item), retrieves at least a portion of the user data associated with the user from the wallet 222. Thereafter, the checkout traversal module 212 transmits automatically at least the portion of the user data associated with the user to the merchant of the request. The checkout traversal module 212 is also configured to send the details associated with request to the merchant. In an embodiment, the checkout traversal module 212 is configured for checking the validity of the details associated with the request before sending the details to the merchant. In an embodiment, the verification associated with the request may include but not limited to address verification, card Luhn checksum verification, and the like. It is to be noted that in the present invention the details associated with the request and/or the at least portion of the user data may be transmitted to the merchant if the request includes valid authentication information of the user. In one example, the valid authentication information may correspond to a successful entry of the login id and password of the web transaction system 200. In another example, the user may have to answer one or more security questions for identification and the initiation of the request along with the submission of the username and password for the web transaction system 200.

The checkout traversal module 212 then facilitates the automatic registering process with the merchant from where the at least one item is to be purchased. In order to initiate the process of registering with the merchant, the checkout traversal module 212 will determine if the merchant is an old merchant (that is, the user has already made a prior purchase) or a new merchant (that is, the user is making a purchase for a first time with the merchant).

In one embodiment, if the at least one merchant is found to be the old merchant, then the checkout traversal module 212 directly log into the website of at least one merchant, by retrieving and using the pre-stored username and password corresponding to the at least one merchant stored in the wallet 222 or may be presented in the request. Thus, it is to be noted that the checkout traversal module 212 may facilitate direct logging into website of all merchants of the one or more merchants on repeated visits automatically. This allows the user to not have to retype information for each of the one or more merchant's registration, and may have different profiles for different merchants stored in the wallet 222 that can be retrieved by the checkout traversal module 212 for logging into website of the any repeated merchant of the one or more merchants.

In another embodiment, if the merchant is found to be the new merchant, the checkout traversal module 212 then facilitates the registration process with the merchant. The checkout traversal module 212 will then submit the inputs required for completing the registration with the merchant by retrieving inputs from the wallet 222 or the request. In this case, the checkout traversal module 212 will also analyze the merchant website data requirement, and thereafter determines what inputs (data) of the user is required for registration and how does their registration system work. In addition, the checkout traversal module 212 further determines the data privacy policies of the website of the merchant. Thus, once the checkout traversal module 212 determines the registration requirement of the website of the merchant, the checkout traversal module 212 then submits the appropriate user data retrieved from the wallet 222 or the request for registration and subsequently logs into the website of the merchant data. In yet another embodiment, if the merchant is found to be the new merchant, the checkout traversal module 212 then facilitates automatic generation and entry of a login username and a password for logging into the website corresponding to the merchant. In yet another embodiment, if the merchant is found to be the new merchant, the checkout traversal module 212 then facilitates automatic logging into the website corresponding to at the merchant using a guest checkout option available at the website corresponding to the merchant.

In an embodiment, one or more notifications based on the request are presented to the user by the presentation module 214 using the checkout traversal module 212 if any issues with regard to the adding of the at least one item to a shopping cart at the merchant are discovered by the checkout traversal module 212. The one or more notifications may comprise of notifications related to non-availability of the at least one item at the one or more merchants, non-availability of color preference of the at least one item, non-availability of size preferences of the at least one item, non-availability of quantity of the at least one item, incorrect price of the at least one item, or updated price of the at least one item. In another embodiment, one or more notifications may comprise of presenting recommended products identified by the transaction server 110 or identified by the merchant.

After successful logging into the merchant website by the checkout traversal module 212, then the checkout traversal module 212 initiates the automatic transmitting of at least the portion of the user data associated with the user to the merchant of the request. The checkout traversal module 212 thus facilitates the adding of the at least one item in the request to the shopping cart at the merchant. In an embodiment, the shopping cart is a virtual container for items that the user may want to purchase. The checkout traversal module 212 selects the at least one item of the user in the website of the merchant, which is then added to the shopping cart on behalf of the user. The merchant website may contain the description of the at least one item chosen by the checkout traversal module 212, including the unit price, quantity, shipping fees, taxes, total unit price of the at least one item.

In one embodiment, if the user may have visited the merchant before, the user may customize the shopping cart with specific rules that are associated with a unique basket D. For example, the user may allow the web transaction system 200 to purchase up to only a limited amount of items in each category. Alternatively, the user can specify that no check out process for the shopping cart is allowed by the web transaction system 200, and approval for a check out is required from the user. Thus, when the checkout traversal module 212 puts the at least one item into the shopping cart as desired, if the shopping cart is customized with user defined rules, the rules are checked whenever the at least one item is put into the shopping cart.

It is to be noted that in any other embodiments of the present invention the checkout traversal module 212 may facilitate adding of one or more items in one or more shopping carts at the merchant or a plurality of merchants simultaneously or sequentially without moving out from the scope of disclosed embodiments.

Thereafter, the checkout traversal module 212 facilitates the automatic filling/selecting of one or more fields at the merchant with at least the portion of the user data. The one or more fields includes one or more shipping fields, one or more payment fields, one or more billing fields, and one or more discount code fields. It will be apparent to a person with ordinary skills in the art that one or more fields are not limited to above-mentioned fields and may include any other fields without moving out of the scope of disclosed embodiments. The checkout traversal module 212 initially identifies and analyses the information to be filled/selected in the one or more fields. Then the checkout traversal module 212 subsequently retrieves the inputs to the one or more fields form the details communicated in the request or with the user data retrieved from the wallet 222, and fills/selects the one or more fields at the website of the merchant. In another embodiment, the filling/selecting of the one or more fields at the merchant for the web-based purchase is facilitated by the checkout traversal module 212 with a default preference from one or more default preferences for each of the one or more fields associated with the merchant. In one embodiment, the one or more default preferences may be presented in the request. In another embodiment, the one or more default preferences corresponding to a specific merchant of the one or more merchants are stored in the wallet 222 for each of the one or more merchants, which have been previously visited by the user. In an embodiment, the default preferences may include one or more shipping method details and the like.

The one or more fields further include fields such an installation date, a warranty selection option, a gift wrapping selection option, one or more discount code fields, and a delivery date. In one embodiment, the filling/selecting of the above mentioned one or more fields at the merchant for the web-based purchase is facilitated by the checkout traversal module 212 with the information presented by the user in the request or with the user data retrieved from the wallet 222. In another embodiment, the one or more fields are presented to the user by the presentation module 214 for filling/selecting of the one or more fields. Herein, the user is required to submit and fill/select the answers to the one or more fields and submit back to the web transaction system 200.

While the checkout traversal module 212 is facilitating the checkout processing of the request at the merchant, the presentation module 214 is configured for presenting to the user on his/her computing device one or more status messages pertaining to the checkout processing of the request. The one or more status message includes the messages indicating that the at least one item is added to the shopping cart, the shipping details are sent, the payment details are sent, waiting for the merchant for confirmation, or the like. It may be apparent to a person with ordinary skill in the art that the one or more status message described above are only limited to one embodiment, and may include any other messages without moving out of the scope of the present invention. It is to be noted that in any other embodiments of the present invention the checkout traversal module 212 may facilitate presenting to the user on his/her computing device one or more status messages pertaining to the checkout processing of the request at the merchant or a plurality of merchants without moving out from the scope of disclosed embodiments.

Once the checkout processing of the request is completed, the reviewing module 216 is configured for generating one or more review order messages associated to the request. The one or more review order messages are then presented to the user on the computing device by the presentation module 214. In an embodiment, the one or more review order messages include information regarding the at least one item. The information may include a picture and description of the at least one item being purchased at the merchant. In another embodiment, the information may contain at least one of one or more filled/selected fields received from the merchant for the confirmation on details of the at least one of the one or more filled/selected fields from the user. In yet another embodiment, the one or more review order messages may contain both the information regarding the at least one item and at least one of the one or more filled/selected fields received from the merchant for the confirmation from the user. In a yet another alternative embodiment, the one or more review order messages may contain change in price of at least one item from the original price presented to a user.

In an embodiment, the user may amend or change the details in the one or more review order messages presented to the user. The details of one of the one or more review order messages may include the price of the at least one item, the quantity of the at least one item, shipping costs, taxes, total purchase cost, payment method details, shipping details, delivery date, and installation date. It is to be noted that in any other embodiments of the present invention the presentation module 214 presents one or more review order messages to the user on his/her computing device corresponding to the merchant or a plurality of merchants without moving out from the scope of disclosed embodiments.

In one embodiment, if the user doesn't change the details presented in the one or more review order messages and confirms the one or more review order messages, then the transaction module 218 facilitates the applying of the web-based purchase for the at least one item at the merchant based on the confirmation of the from the user.

In another embodiment, if the user amends the information presented in the one or more review order messages, then the checkout traversal module 212 is configured for rerunning the checkout processing of the request based on the amendments in the one or more review order messages. For example, if the user changes the quantity of the at least one item being purchased, the shipping method, the shipping address, the delivery date, or the installation date, then the checkout traversal module 212 retransmit the details of the request to the merchant of the request. Thus, in an embodiment, the checkout traversal module 212 will restart the process of adding the at least one item to the shopping cart, and filling/selecting of the one or more fields based on the amendments by the user in the one or more review order messages. In another embodiment, the checkout traversal module 212 will only process the changes suggested by the user rather than restart the process. Once the checkout traversal module 212 completes the processing, the user will again be presented with a new review order message(s) for conformation. Once the user confirms the new review order message(s), then the transaction module 218 facilitates the applying of the web-based purchase for the at least one item at the merchant based on the confirmation from the user.

In yet another embodiment, if the user amends the information presented in the one or more review order messages, then the checkout traversal module 212 is configured for sending the modified information to one or more merchant website on behalf of the user. Once the checkout traversal module 212 completes the modified processing, the user will again be presented with a new review order message(s) for conformation. Once the user confirms the new review order message(s), then the transaction module 218 facilitates the applying of the web-based purchase for the at least one item at the merchant based on the confirmation from the user.

In one embodiment, while the purchase is being performed by the transaction module 218, if there are one or more errors being generated at the website of the merchant, then the one or more errors are captured by the reporting module 220 and presented to the user by the presentation module 214. In one example, the one or more errors may correspond to that the at least one item not available in stock, invalid promotion code, invalid discount code, invalid or no address input, invalid or no shipping field, or invalid payment field.

In another embodiment, if the transaction module 218 completes the web-based purchase successfully for the at least one item, then the presentation module 214 is configured for presenting one or more purchase confirmation messages received from the merchant to the user. The presentation module 214 is further configured to store the one or more purchase confirmation messages in the wallet 222. The one or more purchase confirmation messages comprises details such as merchant name, at least one item SKU, quantity, price, date, payment method, shipping and handling amount, shipping address, taxes, total purchase amount, confirmation number, confirmation receipts, or the like. It is to be noted that in any other embodiments of the present invention the presentation module 214 presents one or more purchase confirmation messages received from the merchant or from a plurality of merchants without moving out from the scope of disclosed embodiments.

FIGS. 3 to 8 is screenshots illustrating various actions performed for facilitating web-based purchases in accordance with at least one embodiment. FIGS. 3 to 8 will now be explained in conjunction with FIG. 1 and FIG. 2.

FIG. 3 is an exemplary screenshot of an online search engine's webpage at a marketplace where a user performs search for one item. In an embodiment, the user performs the search on the computing device. The user may use any suitable search engine at the marketplace over the internet on the computing device without limiting the scope of disclosed embodiments in order to run a search query for any item that the user may want to purchase. Based on the user search query, the list of results pertaining to the item searched is then displayed to the user. Along with the list of results, other relevant options such as selection tabs corresponding to variants of the item are also presented, which may include options to choose the quantity of the item, options to specify price budget range. The option to pre-select specific online retailers that the user is interested in, may also be displayed to the user, based on the search engine that the user is browsing on the computing device.

According to the present invention, the transaction server 110 is compatible with, and can be used in collaboration with any known and existing marketplace such as Google Shopping®, PriceGrabber®, or the like. Thus, it will be apparent to a person with ordinary skill in the art that the disclosed screenshot corresponding to a particular web-based search engine is not intended to limit the scope of the disclosed embodiments. Further, in addition to the web-based search engines, the transaction server 110 is also compatible with other websites, such as but not limited to social networking websites, online email services, blogs, web portals, news websites, informational websites, corporate websites, websites displaying product advertisements, product advertisements displayed to the user while surfing web, product catalogs or the like. As an example, a list of products or a single product advertisement may be displayed to the user while checking his/her Facebook® account or his/her Gmail® account.

As shown in FIG. 3, the search engine displays a list of merchants, such as Best Buy®, Target®, Home Depot®, J. Crew®, etc., which have the searched item (Canon 60d) available for buying. It is further depicted that corresponding to each of the list of merchants displayed, a clickable option ‘ZIPTHRU BUY’ appears on the user interface. The “‘ZIPTHRU BUY’ link corresponds to an option provided to the user to proceed for the purchase of selected product using the transaction server 110. In one embodiment, the clickable option ‘ZIPTHRU BUY’ is coupled to the results corresponding to specific online merchants. The specific merchants may be segregated based on one or more factors such as the complexity of details demanded by the different merchants for processing a shopping deal, the ease of navigating through the shopping web-interface of the merchants, the frequency of merchants website being visited by different users globally, and the authenticity and credibility of the different merchants. In another embodiment, the clickable option ‘ZIPTHRU BUY’ may also appear along with one or more items/merchants displayed while the user is surfing other websites such as social networking websites, online email services, blogs, web portals, news websites, informational websites, or corporate websites.

If the user is interested in purchasing the item from any merchant in the list of merchants, the user will then have to click on the rendered ‘ZIPTHRU BUY’ option corresponding to the selected merchant to purchase the product.

FIG. 4 is an exemplary screenshot of the online search engine's webpage in which the user enter valid authentication details in accordance with at least one embodiment. Once the user clicks on the ‘ZIPTHRU BUY’ option corresponding to the selected merchant to purchase the product, the web page rendered on the user interface at the computing device asks for the user's login credentials (username and password) for accessing the transaction server 110. For example, if the user searches on Google® search engine, then the popping window, as shown in FIG. 4, may ask for the user's login credentials for accessing the transaction server 110. In one embodiment, the window that pops up may overlap the product search results page displayed in FIG. 3. In another embodiment, after clicking the ‘ZIPTHRU BUY’ option, the user may be navigated to a new web page rendering options for the user to input credential details for accessing the transaction server 110.

FIG. 5 is an exemplary screenshot of a webpage that renders one or more options for the user for initiating checkout processing in accordance with at least one embodiment. In an embodiment, post the entry of credentials by the user, the wallet 222 appears on the user interface at the computing device. In an embodiment, the wallet 222 can be a database store maintained by the transaction server 110 or a third party wallet that passes the stored credentials to the transaction server 110 via API calls. The wallet 222 may display at least a portion of user details associated with the user such as credit/debit card details; user's preferable shipping address, or the like. In an embodiment, the user may select the desired user details. In another embodiment, the transaction server 110 may automatically select a preferred mode of payment and/or shipping depending upon one or more discount offers at one or more merchant websites. In yet another embodiment, the transaction server 110 may automatically select a preferred mode of payment and/or shipping based on default preference of the user. The user details are pre-stored in the wallet 222 and are accessible to the user upon successful entry of credentials for accessing the transaction server 110.

In an embodiment, the user needs to register with the transaction server 110 once, and in the user details like full name, billing address, shipping address, required details of a preferred credit/debit for processing purchases on different merchants websites, or the like are registered in the wallet 222. Thus, the next time the user enters the credentials for logging into the transaction server 110 for processing a purchase of a product to be purchased, the wallet 222 may appear automatically on the user interface, for verification. It will be apparent to a person with ordinary skill in the art that the user may create multiple wallets 222 and use any one of them for online shopping in future without moving out from the scope of disclosed embodiments.

In an embodiment, the user may also be provided with an option to edit the information stored in the wallet 222. For example, the user may intend to use a different credit/debit card than used in last/previous purchase, or may wish to pay through a different mode, or, may want the order to be delivered at a different address. In such cases, the user may manually change the details in the wallet 222.

Thus, it is to be noted that whether the user has created the wallet 222, or is using a previously created wallet, a clickable option (such as ‘checkout’, as shown in FIG. 5) appears on the user interface, which the user needs to click to initiate checkout processing of the selected one or more items. On clicking said option, the processing of the user's request is initiated by the transaction server 110 at the website of the merchant.

FIG. 6 is an exemplary screenshot of a webpage displayed to the user while check out processing of the request of the user is being performed in accordance with at least one embodiment. Once the user has clicked the ‘checkout’ option displayed in FIG. 5, the check out processing of the request of the user is initiated. While the check out processing of the request at the website of the selected merchant is initiated, an application programming interface (API) of the transaction server 110 is invoked. Thereafter the transaction server 110 receives the details in the request of the user, including the URL of the online merchant selected by the user for buying the product. The transaction server 110 then runs a script at the backend, where it navigates to the website of the selected merchant using the URL provided by the search engine. At the website of the selected merchant, the transaction server 110 then facilitates the executing of check out processing for the purchase of the item.

The transaction server 110 may facilitate functions such as, but not limited to, adding item to a shopping cart, and entering user credentials on the website of the merchant. In a case where a user account is required to be created at the website of the merchant before processing the purchase, the transaction server 110 may facilitate creating of account at the website of the selected merchant by retrieving and inputting the details from the wallet 222. The transaction server 110 may also facilitate seeking inputs from the user manually for inputting any detail required by the selected merchant during the check out processing of the request. In an embodiment, the transaction server 110 initiates the filling/selecting of one or more fields, wherein said fields may include, but is not limited to, payment card, billing/shipping information, discount codes (if any). In an embodiment, the transaction server 110 may present one or more status messages at the time of initiating the checkout processing such as ‘product out of stock’, price of the product, product options, etc. In an embodiment, in a case, where the selected product is out of stock, after displaying the corresponding message to the user on the computing device, the user may be rerouted to the search results page as depicted in FIG. 3, to select other merchant.

Thus, as depicted in FIG. 6, one or more status messages pertaining to the checkout processing of the request is presented to the user on the computing device while the transaction server 110 is facilitating the checkout processing of the request. The one or more status message includes the messages indicating that the item is added to the shopping cart, the shipping details are sent, the payment details are sent, and waiting for the merchant for confirmation.

FIG. 7 is an exemplary screenshot of a screen displayed to the user presenting a review order message in accordance with at least one embodiment. In an embodiment, after submitting all details required for the checkout processing of the request, the transaction server 110 then facilitates the collection of metadata rendered on the website of the selected merchant, and the ‘review order’ information is rendered to the user. The ‘review order’ information may include, but is not limited to, product quantity, payment method, shipping address/mode, and delivery/installation date details. The layout of a typical screen rendering the ‘review order’ details at the user interface on the computing is shown in FIG. 7. Along with the ‘review order’ details, a clickable option for confirming the placed order details appears, which, if the user clicks, passes a signal to the transaction server 110, indicating confirmation to proceed with the placed order at the website of the merchant. In another embodiment, the user may also have an option to cancel/change the order. In case of cancellation, an order cancellation signal to the transaction server 110 is provided, and the transaction server 110 initiates the cancelling of the order and stops executing any further at the website of the selected merchant. In case of a change in order, an order change signal to the transaction server 110 is provided, along with the information edited by the user.

FIG. 8 is an exemplary screenshot of a screen displayed to the user presenting a purchase confirmation message in accordance with at least one embodiment. In an embodiment, when the user confirms the “review order” information presented on the computing device, the transaction server 110 then facilitates applying of the order at the website of the selected merchant on behalf of user. While the purchase is being processed, the merchant may verify the validity of user details, as plugged-in by the transaction server 110. The verification may include checking whether the entered shipping address is a valid address, the entered credit/debit card details for processing the purchase are valid, for which the selected merchant may contact a bank/financial institution. If there is any discrepancy identified in the entered details by the selected merchant, the transaction server 110 retrieves the error message corresponding to the identified discrepancy rendered on the website of the selected merchant, and presents it to the user on the computing device. In another embodiment, the discrepancy such as ‘product out of stock’, ‘invalid shipping addresses, etc., are also eventually passed on to the user on the computing device, by the transaction server 110, if identified. In an embodiment, in a case, where the selected product is out of stock, after displaying the corresponding message to the user on the computing device, the user may be rerouted to the search results page as depicted in FIG. 3, to select other merchant.

In an embodiment, if the user details are successfully processed and the selected merchant confirms the placed order, the transaction server 110 then fetches metadata corresponding to the order confirmation details, such as the confirmation code, the amount charged, delivery date, etc., from the website of the selected merchant, and presents the order conformation details to the user. In another embodiment, the transaction server 110 retrieves the URL for viewing a receipt of the placed order, from the website of the selected merchant and provides a link for viewing the order receipt at the website of the selected merchant, to the user, along with the snapshot of the order confirmation webpage.

FIG. 9 is a flow diagram illustrating a method implementable on a transaction server for facilitating web-based purchases in accordance with at least one embodiment. FIG. 9 will now be explained in conjunction with FIG. 1 and FIG. 2.

At step 902, a request is received from a user to make a purchase for at least one item of goods or services at one or more merchants. In an embodiment, the request from the user to make the purchase for the at least one item of goods or services from at least one merchant of the one or more merchants is received by a purchase request module 210. In the present invention, the user after selecting the at least one item from the at least one merchant (without visiting the website of the at least one merchant) raises a request to make a purchase for the purchasing of the at least one item. In an embodiment, the request may include user credentials for authenticating with the transaction server 110.

In an embodiment, once the user is authenticated with the transaction server 110 using an authentication module, the transaction server 110 may presents a user with one or more review order messages in order to confirm the purchase. The review order messages may include information related to but not limited to shipping information, tax, total price after discount is applied, options for the product, shipping options, etc. Based on the one or more review messages, the user has all the information before they initiate the purchase. In another embodiment, once the user is authenticated the user is presented with one or more options for selecting a payment method, shipping method, shipping address or the like. In yet another embodiment, once, the user is authenticated with the transaction server 110 using an authentication module; the transaction server 110 may automatically select a preferred mode of payment and/or shipping depending upon one or more discount offers at one or more merchant websites. In yet another alternative embodiment, the transaction server 110 may automatically select a preferred mode of payment and/or shipping based on default preference of the user.

At step 904, transmit automatically at least a portion of user data associated with the user to the one or more merchants for a checkout processing of the request. In an embodiment, the check out processing of the request is initiated by a checkout traversal module 212. The checkout traversal module 212 facilitates the registration with the at least one merchant from where the at least one item is to be purchased, and subsequently logs into the website of the at least one merchant. The registration is completed by automatically transmitting at least the portion of the user data associated with the user to the website of the at least one merchant. The user data associated with the user may be presented in the request or may be retrieved from a wallet 222. In an embodiment, the checkout traversal module 212 then facilitates automatic generation and entry of a login username and a password for logging into the website corresponding to the merchant. In yet another embodiment, the checkout traversal module 212 then facilitates automatic logging into the website corresponding to at the merchant using a guest checkout option available at the website corresponding to the merchant.

In one embodiment, the user data is provided to the at least one merchant if the request includes valid authentication information for the user.

At step 906, the at least one item of goods or services is added to one or more shopping carts at the one or more merchants. In an embodiment, the adding of the at least one item in the request to at least one of the one or more shopping cart at the at least one merchant is facilitated by the checkout traversal module 212. In an embodiment, the shopping cart is a virtual container for items that the user may want to purchase. The checkout traversal module 212 thus selects the at least one item in the website of the at least one merchant, which is then added to the at least one shopping cart on behalf of the user. Once the at least one order item is automatically placed in the at least one shopping cart, it may be later deleted or the quantity may be changed as required. It is to be noted that in any other embodiments of the present invention the checkout traversal module 212 may facilitate adding of one or more items in one or more shopping carts at the merchant or a plurality of merchants simultaneously without moving out from the scope of disclosed embodiments.

At step 908, one or more fields are filled/selected at the one or more merchants with at least the portion of the user data. The one or more fields includes one or more shipping fields, one or more payment fields, one or more billing fields, one or more discount code fields, an installation date, and a delivery date. Initially, the checkout traversal module 212 initially identifies and analyses the information to be filled/selected in the one or more fields. Thereafter, in one embodiment, the automatic filling/selecting of one or more fields at least one merchant of the one or more merchants with at least the portion of the user data is facilitated by the checkout traversal module 212. In another embodiment, the filling/selecting of the one or more fields at the at least one merchant for the web-based purchase is facilitated by the checkout traversal module 212 with a default preference from one or more default preferences retrieved from the wallet 222 or presented in the request. In another embodiment, at least one of the one or more fields may be presented to the user by the presentation module 214 for filling/selecting of the at least one of the one or more fields.

At step 910, one or more status messages pertaining to the checkout processing is presented to the user. In an embodiment, while the checkout processing of the request at the at least one merchant is facilitated by the checkout traversal module 212, a presentation module 214 is configured for presenting to the user on the computing device the one or more status messages pertaining to the checkout processing of the request. The one or more status message includes the messages indicating that the at least one item is added to the shopping cart, the shipping details are sent, the payment details are sent, waiting for the merchant for confirmation, or the like. It is to be noted that in any other embodiments of the present invention the checkout traversal module 212 may facilitate presenting to the user on his/her computing device one or more status messages pertaining to the checkout processing of the request at the merchant or a plurality of merchants without moving out from the scope of disclosed embodiments.

At step 912, one or more review order messages are presented to the user for confirmation. In an embodiment, once the checkout processing of the request is completed, the one or more review order messages associated to the request are generated by a reviewing module 216. The one or more review order messages are then presented to the user on the computing device by the presentation module 214. In an embodiment, the one or more review order messages include information regarding the at least one item of goods or services. The information may include a picture and description of the at least one item being purchased at the at least one merchant, and at least one of one or more filled/selected fields received from the at least one merchant. For example, the details of one of the one or more review order messages may include the price of the at least one item, shipping costs, taxes, total purchase cost, payment method details, net price after applying discounts/coupon codes, shipping methods, delivery date, and shipping details. In an embodiment, the user may amend the details in one or more review order messages presented to the user. It is to be noted that in any other embodiments of the present invention the presentation module 214 presents one or more review order messages to the user on his/her computing device corresponding to the merchant or a plurality of merchants without moving out from the scope of disclosed embodiments.

At step 914, the web-based purchase for at least one item of goods or services is applied at the one or more merchants based on the confirmation. In an embodiment, if the user doesn't change the details and confirms the one or more review order messages, then the applying of the web-based purchase for the at least one item at the at least one merchant based on the confirmation from the user is facilitated by a transaction module 218.

While the purchase is being performed, if there are one or more errors being generated, then the one or more errors are presented to the user by a reporting module 220. If the web-based purchase is completed successfully for the at least one item by the transaction module 218, then the presentation module 214 is configured for presenting one or more purchase confirmation messages received from the at least one merchant to the user. The one or more purchase confirmation messages comprises details such as merchant name, at least one item SKU, quantity, price, date, payment method, shipping and handling amount, shipping address, taxes, total purchase amount, confirmation number, confirmation receipts, or the like. It is to be noted that in any other embodiments of the present invention the presentation module 214 presents one or more purchase confirmation messages received from the merchant or from a plurality of merchants without moving out from the scope of disclosed embodiments.

FIG. 10 is an exemplary screenshot of an initial review order screen for checkout confirmation from a user that lists information related to total cost of at least one item, taxes, one or more selectable options related to at least one item, shipping address, payment method details, etc. in one page.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, WiFi, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, JavaScript, Java, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, ‘Android’, ‘Apple iOS, and ‘Linux’

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product facilitating web-based purchases, as described above, have various advantages. The disclosed methods and systems enable the user with the convenience to shop online, social, or mobile (e.g. website of a marketplace (online), a shopping app (mobile) or from a social networking post (social)) without the need to visit merchant website that has the desired product/service available for sale. The disclosed methods and systems further avoids the need for the user to plug-in the necessary billing, payment, shipping and other details on the merchant's website, without compromising the security of the user's information, authentication information, and personal details.

Various embodiments of the method and system for facilitating web-based purchases have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof. It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method implementable on a transaction server for facilitating a web-based purchase at one or more merchant websites, the transaction server interconnected with one or more users and the one or more merchant websites through a network, the method comprising:
receiving a request from a user to make a purchase for at least one item of goods or services at the one or more merchant websites without the user visiting a website corresponding to each of the one or more merchants;
transmitting automatically at least a portion of user data associated with the user to the one or more merchant websites for a checkout processing of the request;
the checkout processing comprising:
adding the at least one item of goods or services to one or more shopping carts at the one or more merchant websites; and
filling at least one of one or more fields at the one or more merchant websites with at least the portion of the user data;
presenting to the user:
one or more status messages pertaining to the checkout processing of the request either before the checkout processing or during the checkout processing of the request at the one or more merchant websites; and
one or more review order messages corresponding to the at least one item of goods or services and at least one of one or more filled fields received from the one or more merchant websites for confirmation; and
applying the web-based purchase for the at least one item of goods or services at the one or more merchant websites based on the confirmation, wherein one or more purchase confirmation messages are received from the one or more merchant websites based on the applying, and wherein the one or more purchase confirmation messages are presented to the user.

2. The method implementable on the transaction server of claim 1 further comprising storing at least the portion of the user data associated with the user in a wallet, wherein the portion of the user data comprises one or more user payment method details, one or more shipping details, one or more shipping methods, one or more user login details corresponding to the one or more merchants, one or more promotional discount codes corresponding to the one or more merchants, and one or more default preferences for the one or more payment method details, one or more shipping details, and one or more shipping methods.

3. The method implementable on the transaction server of claim 2, wherein one of the one or more default preferences corresponds to a default preference for a specific merchant of the one or more merchant websites.

4. The method implementable on the transaction server of claim 1, wherein the request comprises details corresponding to the at least one item to be selected, color preference of the at least one item, size preferences of the at least one item, quantity of the at least one item, and login credentials of the user for authenticating with the transaction server.

5. The method implementable on the transaction server of claim 1, wherein the user data is only provided to the one or more merchant websites if the request includes valid authentication information for the user to access the transaction server.

6. The method implementable on the transaction server of claim 1, wherein the checkout processing further comprises logging into the website corresponding to at least one of the one or more merchant websites with a pre-stored user login details corresponding to the at least one of the one or more merchant websites present in the user data.

7. The method implementable on the transaction server of claim 1, wherein the checkout processing further comprises generating a login username and a password for logging into the website corresponding to at least one of the one or more merchant websites.

8. The method implementable on the transaction server of claim 1, wherein the checkout processing further comprises logging into the website corresponding to at least one of the one or more merchant websites using a guest checkout option available at the website corresponding to at least one of the one or more merchants.

9. The method implementable on the transaction server of claim 1 further comprising presenting the user if there is one or more notifications based on the request, the one or more notifications comprises non-availability of the at least one item at the one or more merchant websites, non-availability of color preference of the at least one item, non-availability of size preferences of the at least one item, non-availability of quantity of the at least one item, incorrect price of the at least one item, updated price of the at least one item.

10. The method implementable on the transaction server of claim 1, wherein the one or more fields comprises one or more shipping fields, one or more payment fields, one or more billing fields, an installation date, a warranty selection option, a gift wrapping selection option, one or more discount code fields, and a delivery date.

11. The method implementable on the transaction server of claim 1 further comprising filling the at least one of the one or more fields at the one or more merchant websites for the web-based purchase with a default preference from one or more default preferences for each of the one or more fields.

12. The method implementable on the transaction server of claim 1 further comprising presenting the at least one of the one or more fields at the one or more merchant websites for the web-based purchase to the user for filling the at least one of the one or more fields.

13. The method implementable on the transaction server of claim 1 further comprising allowing the user to edit content presented in the one or more review order messages, wherein each of the one or more review order messages comprises name of the at least one item of goods or services, price of the at least one item of goods or services, shipping costs, taxes, total purchase cost, payment method details, shipping method, shipping address, and terms & conditions for performing the purchase for the at least one item of goods or services at the one or more merchant websites.

14. The method implementable on the transaction server of claim 1 further comprising reporting of one or more errors to the user in the one or more review order messages or after applying for the web-based purchases, wherein the one or more errors correspond to at least one of that the at least one item of goods or services is not available in stock,

15. The method implementable on the transaction server of claim 1 further comprising rerunning the checkout processing of the request if the user changes one or more inputs of the request, wherein the one or more inputs corresponds to a quantity of the at least one item of goods or services, one or more options related to the at least one item, payment fields, shipping methods, a shipping address, a delivery date, and an installation date.

16. The method implementable on the transaction server of claim 1 further comprising storing one or more purchase details after the applying of the web-based purchase, wherein the one or more purchase details corresponds to a merchant name, a product SKU, a product quantity, a product price, a purchase date, a payment method selected, a shipping method selected, a promotion code applied, a discount code applied, a shipping address, a payment tax, a confirmation number, and a confirmation receipt.

17. The method implementable on the transaction server of claim 1 further comprising tracking the one or more merchant websites to obtain information from the one or more merchant websites regarding at least the web-based purchase of the at least one item of goods or services and a commission payment.

18. A web transaction system for facilitating a web-based purchase at one or more merchant websites, the web transaction system comprising:
a purchase request module configured for receiving a request from a user to make a transaction module for at least one item of goods or services at the one or more merchant websites without the user visiting a website corresponding to each of the one or more merchants;
a checkout traversal module configured for a checkout processing of the request, wherein the checkout traversal module transmits automatically at least a portion of user data associated with the user to the one or more merchant websites of the request, adds the at least one item of goods or services to one or more shopping carts at the one or more merchant websites, and fills at least one of one or more fields at the one or more merchant websites with at least the portion of the user data;
a presentation module configured for presenting to the user one or more status messages pertaining to the checkout processing of the request by the checkout traversal module while the checkout traversal module performs the checkout processing of the request at the one or more merchant websites;
a reviewing module configured for generating one or more review order messages corresponding to the at least one item of goods or services, and at least one of one or more filled fields received from the one or more merchant websites for a confirmation from the user, wherein the review order message is presented to the user by the presentation module; and
a transaction module configured for:
applying the web-based purchase for the at least one item of goods or services at the one or more merchant websites based on the confirmation; and
generating one or more purchase confirmation messages, wherein the one or more purchase confirmation messages is presented to the user by the presentation module.

19. The web transaction system of claim 18 further comprising a reporting module configured for reporting of one or more errors to the user in the one or more review order messages or after applying for the web-based purchases to the presentation module, wherein the one or more errors correspond to at least one of that the at least one item of goods or services is not available in stock, invalid promotion code, invalid discount code, invalid or no address input, invalid or no shipping field, or invalid payment field.

20. The web transaction system of claim 18 wherein the checkout traversal module is further configured for rerunning the checkout processing of the request if the user changes one or more inputs of the request, wherein the one or more inputs corresponds to a quantity of the at least one item of goods or services, a payment field, a shipping method, a shipping address, a delivery date, or an installation date.

21. A computer program product for use with a computer, the computer program product comprising a computer-usable data carrier storing a computer-readable program code embodied therein, the computer-readable program code configured for facilitating a web-based purchase at one or more merchant websites on a transaction server, the computer-readable program code comprising:
program instruction means for receiving a request from a user to make a purchase for at least one item of goods or services at the one or more merchant websites without the user visiting a website corresponding to each of the one or more merchants;
program instruction means for transmitting automatically at least a portion of user data associated with the user to the one or more merchant websites for a checkout processing of the request; the checkout processing comprising:
adding the at least one item of goods or services to one or more shopping carts at the one or more merchant websites; and
filling at least one of one or more fields at the one or more merchant websites with at least the portion of the user data;
program instruction means for presenting to the user:
one or more status messages pertaining to the checkout processing of the request while performing the checkout processing of the request at the one or more merchant websites; and
one or more review order messages corresponding to the at least one item of goods or services and at least one of one or more filled fields received from the one or more merchant websites for confirmation; and
program instruction means for applying the web-based purchase for the at least one item of goods or services at the one or more merchant websites based on the confirmation, wherein one or more purchase confirmation messages are received from the one or more merchant websites based on the applying, and wherein the one or more purchase confirmation messages are presented to the user.
